(19) United States
(12) Patent Application Publication
(10) Pub. No.: US 2016/0065629 A1
(43) Pub. Date: Mar. 3, 2016

(54) System and Method for Proximity-based Social Networking

(71) Applicant: Interact Technology, LLC, Dayton, OH (US)

(72) Inventor: Michael J. Emoff, Dayton, OH (US)

(21) Appl. No.: 14/514,571

(22) Filed: Oct. 15, 2014

Related U.S. Application Data
(60) Provisional application No. 62/043,492, filed on Aug. 29, 2014.

(51) Int. Cl. H04L 29/06; G06F 17/30; G06F 3/0484; H04L 12/26

(52) U.S. Cl. CPC H04L 65/403; H04L 43/045; G06F 17/30; G06F 3/0484

(57) ABSTRACT

A method for proximity-based social networking may include: (1) identifying a location of a first computing device of a first user, (2) identifying a location of a second computing device of a second user, and (3) displaying, by the first computing device, content associated with the second user if the second computing device is located within a predefined proximity of the first computing device.

### PRIORITY

This application is a non-provisional of, and claims priority from, U.S. Ser. No. 62/043,492 filed on Aug. 29, 2014, the entire contents of which are incorporated herein by reference.

### FIELD

The present disclosure is generally related to social networking services and, more particularly, to systems and methods for proximity-based social networking.

### BACKGROUND

Social networking services are a popular way for people to communicate with friends, colleagues and relatives. Social networking services provide the ability for users to create and share various social media content. Such content may be stored on a service provider's server and may be accessed by other users connected to the user. For example, social networking services may allow users to connect with other users based on common relationships and/or interests.

Most social networking services operate without regard to the user's current geographic location. Some social networking services allow shared content to be related to a particular geographic location. However, existing social networking services may not allow users to automatically share content with nearby users, particularly, users that are not already connected through the social networking service.

Accordingly, those skilled in the art continue with research and development efforts in the field of social networking services.

### SUMMARY

In one embodiment, the disclosed method may include: (1) identifying a location of a first computing device of a first user, (2) identifying a location of a second computing device of a second user, and (3) displaying, by the first computing device, content associated with the second user if the second computing device is located within a predefined proximity of the first computing device.

In one embodiment, the disclosed system may include: a server, a database in electronic communication with the server, and a plurality of computing devices of a plurality of users in electronic communication with the server, wherein the database includes locations of the plurality of computing devices of the plurality of users and content associated with the plurality of users, and wherein each computing device of the plurality of computing devices includes computer-readable storage medium including instructions that, when executed by the computing device, causes the computing device to perform operations including: (1) identifying a location of a first computing device of a first user, (2) identifying a location of a second computing device of a second user, and (3) displaying content associated with the second user if the second computing device is located within a predefined proximity of the first computing device.

In one embodiment, the disclosed computer-readable storage medium including instructions that, when executed by a processor, causes the processor to perform operations including: (1) identifying a location of a first computing device of a first user, (2) creating a geo-fence around the location of the first computing device based on a predefined proximity, (3) identifying a location of a second computing device of a second user, (4) determining whether the location of the second computing device is within the geo-fence, (5) determining the location of the second computing device relative to the location of the first computing device within the geo-fence, (6) determining a bearing of the first computing device, (7) determining whether the bearing is substantially aligned with the location of the second computing device, and (8) displaying, by the first computing device, content associated with the second user if the second computing device is located within the geo-fence and if the bearing of the first computing device is substantially aligned with the location of the second computing device.

Other embodiments of the disclosed system and method for proximity-based social networking will become apparent from the following detailed description, the accompanying drawings and the appended claims.

### BRIEF DESCRIPTION OF THE DRAWINGS

FIG. 1 is a schematic block diagram of one embodiment of the disclosed proximity-based social network;

FIG. 2 is a schematic block diagram of one embodiment of the disclosed system for proximity-based social networking;

FIG. 3 is a schematic block diagram of one embodiment of the computing device represented in FIGS. 1 and 2;

FIG. 4 (FIGS. 4A and 4B) is flow diagram of one embodiment of the disclosed method for proximity-based social networking;

FIG. 5 is a schematic illustration of one embodiment of the graphical user interface for displaying content associated with the user;

FIG. 6 is a schematic illustration of another embodiment of the graphical user interface for displaying content associated with the user; and

FIG. 7 is a schematic illustration of another embodiment of the graphical user interface for displaying the message associated with the user.

### DETAILED DESCRIPTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

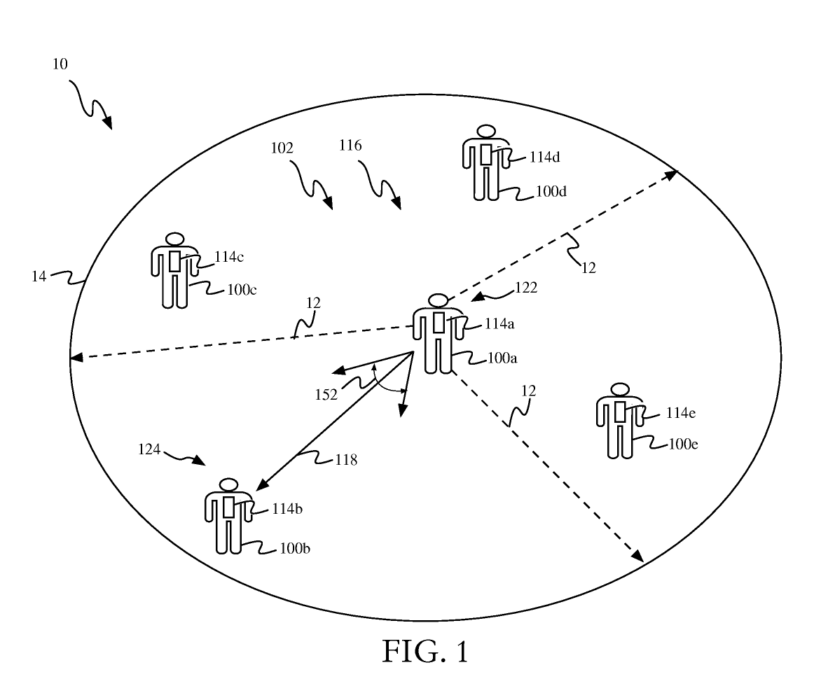

Referring to FIG. 1, in general, the present disclosure is directed to techniques that may facilitate a user 100 (identified particularly as user 100a, 100b, 100c, 100d and 100e) in identifying, locating, and communicating with one or more users 100 (e.g., of a plurality of users 102) of the user's proximity-based social network 10. Techniques of the present disclosure may enable a first user 100a to discover (e.g., locate) and/or communicate with a second user 100b (and/or a third user 100c, a fourth user 100d, a fifth user 100e, etc.) of the proximity-based social networking service within a predetermined proximity 12 (e.g., distance) of the first user 100a.

The predetermined proximity 12 may define or generate a virtual perimeter (e.g., of a real-world geographic area) around the user 100, referred to herein as a geo-fence 14. The geo-fence 14 may define the zone of interaction between physically proximate computing devices 114. The predetermined proximity 12 may be adjusted and/or selectively modified by the user 100 to increase or decrease the size of the geo-fence 14. In one example, the predetermined proximity 12 may be set to be small enough that the user 100 can see other users 100 of the plurality of users 112 located within the geo-fence 14. In another example, the predetermined proximity 12 may be set to be large enough to enclose a structure (e.g., a building, a sports stadium, etc.) within the geo-fence 14. In another example, the predetermined proximity 12 may be set to be large enough to encompass a larger geographic area (e.g., a neighborhood, a street block, etc.) within the geo-fence 14. A predefined proximity 12 of any size (e.g., a geo-fence 14 of any size) is contemplated. For example, the dimension (e.g., linear distance) of the predefined proximity 12 may extend from a few inches to infinity.

While the geo-fence 14 is shown in FIG. 1 encompassing a rounded, oval-shaped geographic area, those skilled in the art will appreciate that the geographic area encompassed by the geo-fence 14 may have various shapes in plan view, including regular shapes and irregular shapes. The shape shown in FIG. 1 is only one very specific, non-limiting example.

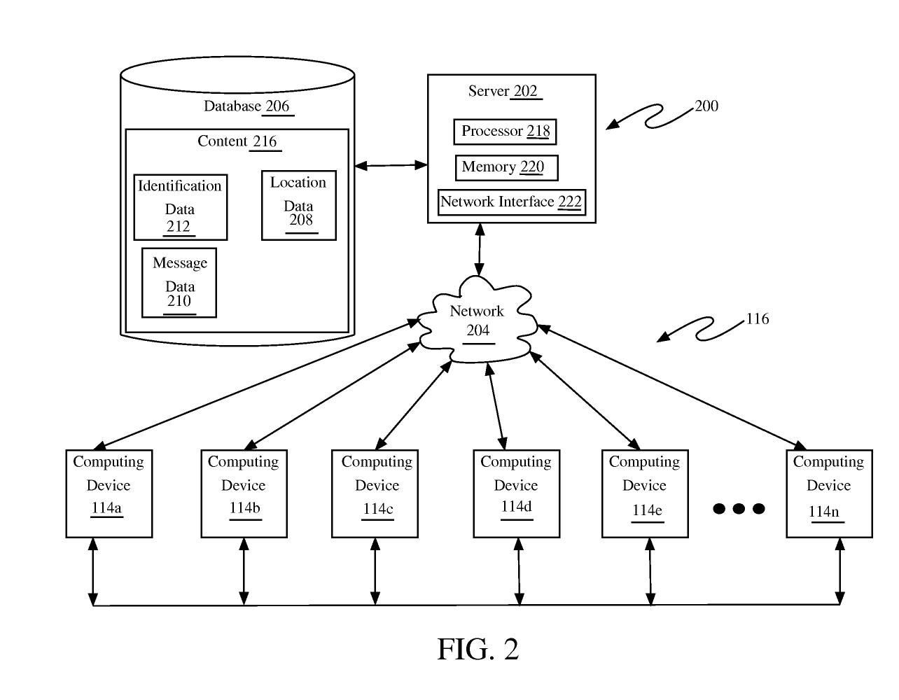

Referring to FIGS. 1 and 2, in one example, a computing device 114 (identified particularly as computing device 114a, 114b, 114c, 114d, 114e) of each user 100 may communicate with a server 202 (FIG. 2) of a proximity-based social networking system 200 to identify and locate another computing device 114 of a plurality of computing devices 116 within the predefined proximity 12 (e.g., located within the geo-fence 14). For example, a first computing device 114a of the first user 100a may detect a second computing device 114b of the second user 100b (and/or a third computing device 114c of the third user 100c, a fourth computing device 114d of the fourth user 100d, a fifth computing device 114e of the fifth user 100e, etc.) and determine a location of the second computing device 114b relative to the first computing device 114a by receiving location data from the server 202 of the proximity-based social networking system 200. As one example, the plurality of computing devices 114 and the server 202 may communicate with one another over a network 204.

Unless otherwise indicated, the terms “first,” “second,” “third,” etc. are used herein merely as labels, and are not intended to impose ordinal, positional, or hierarchical requirements on the items to which these terms refer.

In another example, each computing device 114 of the plurality of computing devices 116 (e.g., of the proximity-based social networking system 200) may communicate with one another to identify and locate another computing device 114 within the predefined proximity 12. For example, the first computing device 114a may detect and determine a location of the second computing device 114b (and/or the third computing device 114c, the fourth computing device 114d, the fifth computing device 114e, etc.) by receiving location information from the second computing device 114b (and/or the third computing device 114c, the fourth computing device 114d, the fifth computing device 114e, etc.). As one example, the plurality of computing devices 114 may communicate with each other using short-range communication and/or the network 204.

In yet another example, the computing device 114 may communicate with the server 202 (FIG. 2) and with other computing devices 114 of the plurality of computing devices 116 (e.g., of the proximity-based social networking system 200) to identify and locate another computing device 114 of a plurality of computing devices 116 within the predefined proximity 12. As one example, the plurality of computing devices 114 and the server 202 may communicate with one another using short-range communication and/or the network 204.

In response to a selected operating condition of the computing device 114, the computing device 114 may display content 216 associated with the user 100 of another computing device 114 within the predefined proximity 12. Optionally, one or more filters may be selected to limit which users 100 (and associated content 216) are displayed by the first computing device 114a. As one example, a friends-only filter may be applied such that only the content 216 of users 100 that are also friends (e.g., FACEBOOK® friends, pre-designated friends, etc.) may be displayed. As another example, a female-only (or male-only) filter may be applied such that only the content 216 of users 100 that are female (or male) may be displayed. Various other filters may be applied without departing from the scope of the present disclosure.

Content 216 associated with the user 100 may include, but is not limited to, location data 208 associated with the computing device 114 of the user 100, message data 210 associated with the user 100, identification data 212 associated with the user 100, an image of the location of the user 100, and the like. As one example, content 216 associated with the user 100 of another computing device 114 may be displayed anytime the user 100 of another computing device 114 is within the predefined proximity 12. As another example, content 216 associated with the user 100 of another computing device 114 may be displayed by substantially aligning a bearing 118 of the computing device 114 with the location of another computing device 114 within the predefined proximity 12. As will described in more detail herein below, the manner in which the content 216 is displayed by the computing device 114 and the action that initiates display by the computing device 114 may depend on the particular operating condition.

Referring to FIG. 2, in one embodiment of the proximity-based social networking system 200 that provides a computer-implemented proximity-based social networking service, the server 202 may communicate with computing devices 114 (computing devices 114a-114n) via the network 204 and/or coordinate communications between computing device 114, such that computing devices 114 may determine whether they are physically proximate of each other (e.g., within the predefined proximity 12 of another computing device 114).

The server device 202 may include one or more computing devices including, but not limited, to a server computing device and the like, or may include a cloud computing service. A cloud computing service may include one or more remote servers that may provide one or more services including, but not limited, to computation, software, data access, and/or storage services. In one example, server 202 may include at least a processor 218, a memory 220, and a network interface 222 (e.g., any suitable network interface controller). The server 202 may also include a storage device and/or other components known in the art (not shown). Server 202 may include an operating system that is executable by server 202. The server 202 may include one or more instructions that, when executed by the processor 218, perform functions to provide the proximity-based social networking service.

The network 204 may be any communications network, such as the Internet, a cellular network, a local area network (“LAN”), a wide area network (“WAN”), and the like.

The computing device 114 may be any mobile computing devices including, but not limited, to a mobile phone (e.g., a smartphone), a tablet computer, a personal digital assistant, a handheld computer, a notebook computer, a desktop computer, a media player, and the like, including any combination of two or more of these devices. The computing devices 114 may be the same or different types of devices. As one example, the first computing device 114a and the second computing device 114b may both be mobile phones (e.g., smart phones). As another example, the first computing device 114a may be a mobile phone and the second computing device 114b may be a tablet computer. As another example, the first computing device 114a may be a mobile phone and the second computing device 114b may be a notebook or desktop computer.

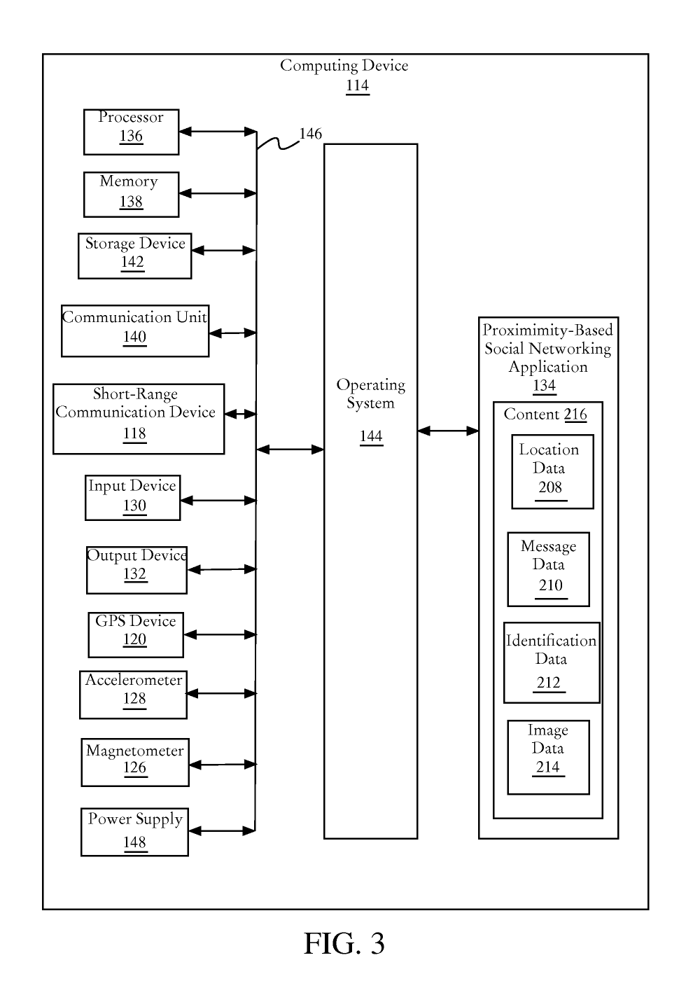

Referring briefly to FIG. 3, the computing device 114 may include a short-range communication device 118 (FIG. 3). The short-range communication device 118 may be any device capable of short-range direct communication with other short-range communication devices via a short-range protocol. The short-range communication device 118 may enable short-range communication directly between computing devices 114. For example, the short-range communication device 118 may be a Bluetooth® device, a radio frequency identification (“RFID”) device, a near-field communication (“NFC”) device, and the like.

Referring to FIGS. 1 and 2, the computing devices 114 may regularly communicate with the server 202. In one example, content 216 may be communicated between the computing devices 114 (e.g., one or more of the plurality of computing devices 116) and the server 202 of the proximity-based social networking system 200. As one example, the computing device 114 may transmit messages (e.g., message data 210) associated with the user 100 to the server 202. As another example, the computing device 114 may transmit location information (e.g., location data 208) for the computing device 114 to the server 202. As another example, the computing device 114 may transmit identification data 212 to the server 202. As another example, the computing device 114 may query the server 202 to detect other proximate computing devices 114 (e.g., other computing devices 114 within the predefined proximity 12 of the computing device 114). The server 202 may store the content 216 associated with the user 100 in a database 206 (FIG. 2).

Location information for the computing device 114 may include any location information (e.g., location data 208) associated with and/or used to determine the location of the computing device 114. As an example, the location of the computing device 114 and/or location information for the computing device 114 may be provided using any suitable form of location detecting technology, location-tracking technology, and/or locating and/or detecting methods to provide the location of the computing device 114. For example, the location of the computing device 114 may be provided from location information manually input by the user 100, Global Positions Systems (GPS), GPS accessed using Bluetooth®, GPS accessed using wireless and/or non-wireless communication, WiFi™ server location data, Bluetooth® based location data, network based triangulation, WiFi™ server information based triangulation, Bluetooth® server information based triangulation, Cell Identification based triangulation, Enhanced Cell Identification based triangulation, Uplink-Time difference of arrival (“U-TDOA”) based triangulation, Time of arrival (“TOA”) based triangulation, Angle of arrival (“AOA”) based triangulation, techniques and systems using a geographic coordinate system (e.g., longitudinal and latitudinal based, geodesic height based, or Cartesian coordinates based systems), Radio Frequency Identification (“RFID”) (e.g., Long range RFID, Short range RFID) and the like.

Referring to FIGS. 2 and 3, as one example, the computing device 114 may send global positioning system (“GPS”) coordinates or any other indication of the location of the computing device 114 to the server 202. For example, the computing device 114 may include a GPS device 120 (FIG. 3). The GPS device 120 may send and receive information from a global navigation satellite system. As one example, the GPS device 120 may receive one or more physical location coordinates from the global satellite system that indicates a position (e.g., location) of the computing device 114. Thus, the GPS device 120 may enable the computing device 114 to determine (e.g., identify) its physical location based on the one or more physical location coordinates. The server 202 may store the location information provided from the GPS device 120 for each computing device 114 in the database 206.

As another example, the computing device 114 may send information associated with the short-range communication device 118 to the server 202. For example, if the short-range communication device 118 is a Bluetooth® device, then the computing device 114 may send a Bluetooth® address associated with the short-range communication device 118 to the server 202. The server 202 may store the location information provided from the short-range communication device 118 for each computing device 114 in the database 206.

In one example implementation, the location data 208 for the computing device 114 may be transmitted to the server 202 manually (e.g., initiated by the user 100). In another example implementation, the location data 208 for the computing device 114 may be transmitted to the server 202 simultaneously with the message associated with the user 100. In another example implementation, the location data 208 may be transmitted to the server 202 regularly. As one example, the computing device 114 may be programmed (e.g., by instructions executed by the computing device 114) transmit (e.g., push) location data 208 to the server 202 at regular intervals. As another example, the server 202 may be programmed to poll (e.g., fetch) the location data 208 from the computing device 114 at regular intervals. Those skilled in the art will recognize that more frequent updates will give more accurate, real-time location information for the computing device 114.

The computing device 114 may generate and/or store the content 216 (e.g., location data 208, message data 210, identification data 212, various copy, and the like) associated with the user 100. As one example, messages data 208 may include any message associated with the user 100 and generated by the computing device 114 (e.g., input by the user 100). For example, the message data 208 may include, but is not limited to, text (e.g., a text message), audio (e.g., an audio message), video (e.g., a video message), an image (e.g., a photograph or meme), or any other sharable content 216. Identification data 212 may include data that identifies the user 100 associated with the computing device 114. For example, identification data 114 may include a user's name, a user's username, a user's photograph (e.g., a profile picture), a user's avatar, and/or any other unique identifier that uniquely identifies the user 100 in the proximity-based social network 10. The server 202 may also store the content 216 associated with the user 100 in the database 206.

Referring to FIGS. 1 and 2, as one non-limiting example of each computing device 114 regularly communicating with the server 202, the first computing device 114a may determine (e.g., identify and/or detect) the location of the first computing device 114a and transmit that location information (e.g., location data 208) to the server 202. The server 202 may store the location data 208 for the first computing device 114a in the database 206. The second computing device 114b may generate content 216 (e.g., a message) associated with the second user 110b and transmit that content 216 to the server 202. The server 202 may store the content 216 (e.g., message data 210, identification data 212, etc.) associated with the second user 100b in the database 206. The second computing device 114b may determine (e.g., identify and/or detect) the location of the second computing device 114b and transmit that location information (e.g., location data 208) to the server 202. Alternatively, the first computing device 114a may determine (e.g., identify and/or detect) the location of the second computing device 114b and store and/or transmit that location information (e.g., location data 208) to the server 202. The server 202 may store the location data 208 for the second computing device 114b in the database 206.

As one non-limiting example of querying the server 202 to detect other proximate computing devices 114, the first computing device 114a may send an indication that the first computing device 114a is interested in discovering other computing devices 114 in physical proximity to the first computing device 114 (e.g., within the predefined proximity 12 of the first computing device 114a). As one example, such a query may occur automatically in response to initiation of a software application (e.g., instructions) executed by the processor 136 of the computing device 114 and/or the processor 218 of the server 202, such as a proximity-based social networking application 134 (FIG. 3).

The server 202 may provide the location of the second computing device 114b to the first computing device 114a if the second computing device 114b is within the predefined proximity 12 of the first computing device 114a. The server 202 may also provide instructions to and/or coordinate communication between the first computing device 114a and the second computing device 114b to provide the location of the second computing device 114b relative to the first computing device 114a. The location of the second computing device 114b may include the position of the second computing device 114b with respect to a global positioning coordinate system, the position of the second computing device 114b relative to the predefined proximity 12 (e.g., inside or outside of the geo-fence 14) and/or the position of the second computing device 114b relative to the first computing device 114a (e.g., distance and/or orientation of the second computing device 114b with respect to the first computing device 114a). Thus, location of any computing device 114 may include the position of the computing device 114 with respect to a global positioning coordinate system, the position of the computing device 114 relative to the predefined proximity 12 (e.g., of the computing device 114 and/or of another computing device 114) and/or the position of the computing device 114 relative to another computing device 114.

In the preceding and following examples, and as best illustrated in FIG. 1, the first computing device 114a may be considered the initiating computing device 122 and the second computing device 114b (and/or the third computing device 114c, the fourth computing device 114d, the fifth computing device 114e, etc.) may be considered the responding computing device 124 of a communication transaction between computing devices 114 (e.g., between the first computing device 114a and the second computing device 114b) because the first computing device 114a queries the server 202 for location information of the second computing device 114 (and/or the third computing device 114c, the fourth computing device 114d, the fifth computing device 114e, etc.).

However, those skilled in the art will recognize that any computing device 114 of the plurality of computing devices 116 (e.g., the first computing device 114a, the second computing device 114b, the third computing device 114c, the fourth computing device 114d, the fifth computing device 114e, etc.) may be the initiating computing device 122 that queries the server 202 for location information of any other computing devices 114 (e.g., that may be the responding computing device 124) within the predefined proximity 12 of that initiating computing device 122.

Upon identifying (e.g., detecting) one or more computing devices 114 within the predefined proximity 12 (e.g., by the first computing device 114a and/or the server 202), the first computing device 114a (or any initiating computing device 122 within the predefined proximity 12) may receive the content 216 associated with the second user 100b (or any content 216 associated with the user 100 of any responding computing devices 124) at any time second computing device 114b is within the predefined proximity 12 and/or the bearing 118 of the first computing device 114a is substantially aligned with the location of the second computing device 114b.

In one example embodiment, the bearing 118 of the first computing device 114a (or any initiating computing device 122) may be determined by the first computing device 114a.

Referring briefly to FIG. 3, the computing device 114 may include a magnetometer 126 and an accelerometer 128. The magnetometer 126 may measure changes in the Earth's magnetic field and the accelerometer 128 may track the movement of the computing device 114. As one example, the computing device 114 may combine heading data from the magnetometer 126 with roll and pitch data from the accelerometer 128 to determine the bearing 118 (e.g., the orientation, angular position, and/or attitude in space) of the computing device 114 as the computing device 114 is moved.

In one example, substantially aligning the bearing 118 of the first computing device 114a (e.g., the initiating computing device 124) with the location of the second computing device 114b (e.g., the responding computing device 124) may include substantially aligning (e.g., within about 5 to 10 degrees) a vector defining the orientation, angular position, and/or attitude in space of the first computing device 114a with the known (e.g., detected and/or identified) location of the second computing device 114b. In another example, generally aligning the bearing 118 of the first computing device 114a with the location of the second computing device 114b may include generally aligning (e.g., within about 10-25 degrees) a vector defining the orientation, angular position, and/or attitude in space of the first computing device 114a with the known location of the second computing device 114b.

Referring again to FIG. 1, as the position of the first computing device 114a is changed (e.g., as the first computing device 114a is moved through the predefined proximity 12), the first computing device 114a may constantly or continuously update the location (e.g., transmit new location data 208 to the server 202) and bearing 118 of the first computing device 114a. Thus, as the first user 100a moves the first computing device 114a (e.g., moves the first computing device 114a vertically, horizontally, and/or rotates the first computing device 114a about a vertical or horizontal axis), the location and/or the bearing 118 will change according to the new position of the first computing device 114a.

As will be described in more detail herein below, depending upon the operating condition of the first computing device 114a, the content 216 associated with the second user 100b may be received and/or displayed by the first computing device 114a in response to a triggering event. As one example, the triggering event may include the second computing device 114b being located within the geo-fence 14. As another example, the triggering event may include in the second computing device 114b being located within the geo-fence 14 and the bearing 118 being generally aligned with the location of the second computing device 114b. As another example, the triggering event may include the second computing device 114b being located within the geo-fence 14 and the bearing 118 being substantially aligned with the location of the second computing device 114b.

As one example implementation, the different operating conditions and, thus, the triggering event may be based on the size of the predefined proximity 12 (e.g., the size of the geo-fence 14). In such a manner, the first user 100a may not necessarily need to be aware that another computing device 114 is within the predefined proximity 12 (e.g., is located within the geo-fence 14) until the triggering event occurs.

Referring to FIG. 3, the computing device 114 may include input device 130. The input device 130 may be configured to receive input from the user 100 through tactile, audio, and/or video feedback. Examples of the input device 130 may include, but are not limited to, a touch-sensitive and/or a presence-sensitive screen, a mouse, a keyboard, a voice responsive system, a camera, or any other type of device for detecting a command from the user 100.

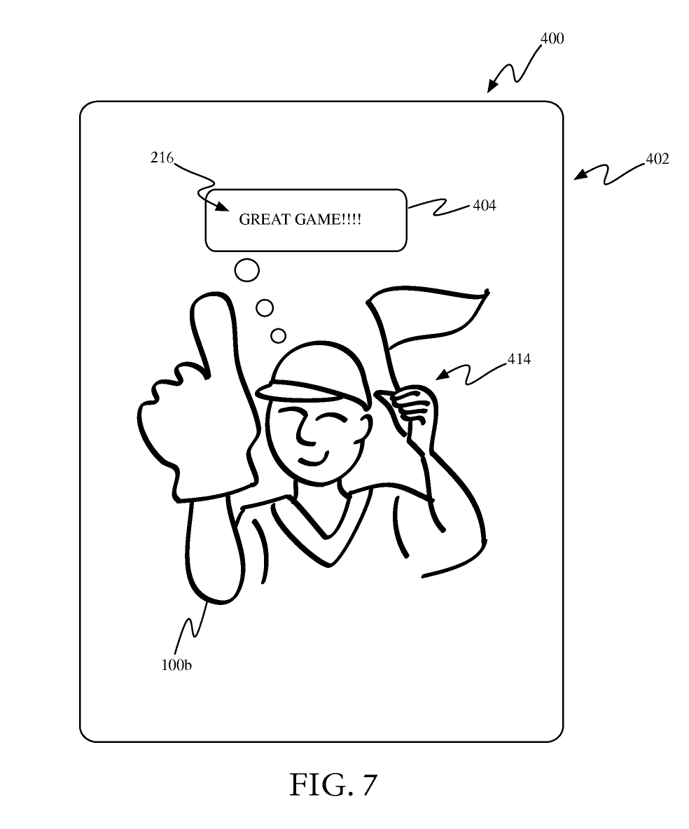

The computing device 114 may include output device 132. The output device 132 may be configured to provide output to the user using tactile, audio, and/or video stimuli. Examples of the output device 132 may include, but are not limited to, a touch-sensitive display, a sound card, a video graphics adapter card, or any other type of device for converting a signal into an appropriate form understandable to humans or machines. The output device 132 may output content such as graphical user interface (“GUI”) 400 (FIGS. 7-9) to the user 100.

In one example, the input device 130 and output device 132 may include a touch screen that enables the user to provide one or more user inputs to interact with the computing device 114 and view output (e.g., content 216).

The computing device 114 may include a processor 136, a memory 138, a communication unit 140, and a storage device 142. The computing device 114 may include an operating system 144 that is executable by the computing device 114.

The processor 136 may be configured to implement functionality and/or process instructions for execution within computing device 114. For example, processor 136 may be capable of processing instructions stored in the memory 138 or instructions stored on the storage devices 142. The processor 136 may include, but is not limited to, any one or more of a microprocessor, a controller, a digital signal processor (“DSP”), an application specific integrated circuit (“ASIC”), a field-programmable gate array (“FPGA”), or equivalent discrete or integrated logic circuitry.

The memory 138 may be configured to store information within computing device 114 during operation. The memory 138 may be used to store program instructions for execution by processor 136. For example, the memory 138 may be used by software or applications running on the computing device 114 to temporarily store information during program execution. In one example, the memory 138 may be a computer-readable storage medium (e.g., a non-transitory computer-readable storage medium). As an example, the memory 138 may be a temporary memory (e.g., a primary purpose of the memory 138 is not long-term storage). As another example, the memory 138 may be a volatile memory (e.g., the memory 138 does not maintain stored contents when the computing device 114 is turned off). Examples of volatile memory include random access memories (“RAM”), dynamic random access memories (“DRAM”), static random access memories (“SRAM”), and other forms of volatile memories.

The storage device 142 may include one or more computer-readable storage media. As one example, storage device 142 may be configured to store larger amounts of information than the memory 138. For example, the storage device 142 may be configured for long-term storage of information. As an example, the storage devices 142 may include non-volatile memory. Examples of non-volatile memory include magnetic hard discs, optical discs, floppy discs, flash memories, or forms of electrically programmable memories (“EPROM”), electrically erasable and programmable (“EEPROM”) memories or other forms of non-volatile storage elements.

The communication unit 140 may be configured to communicate with external devices via one or communication channels, such as one or more wired and/or wireless networks. For example, the computing device 114 may utilize the communication unit 140 to wirelessly communicate with external devices such as other computing devices 114 and the server 202 (FIG. 2). As one example, the communication unit 140 may be a network interface card or controller (“NIC”), such as an Ethernet card, an optical transceiver, a radio frequency transceiver, or any other type of device that can send and receive information. As another example, the communication unit 140 may include 3G, 4G, and WiFi radios in mobile computing devices.

The computing device 114 may include a power supply 148. For example, the power supply 148 may include one or more batteries, which may be rechargeable and provide power to the computing device 114.

The operating system 144 may control the operation of components of the computing device 114. For example, the operating system 144 may facilitates the interaction of one or more applications and/or modules with the processors 136, the memory 138, the communication unit 140, the storage device 142, the input device 130, the output device 132, the short-range communication device 118, the GPS device 120, the magnetometer 126, the accelerometer 128, and the power supply 148.

Each of illustrated components of the computing device 114 may be interconnected (physically, communicatively, and/or operatively) by a communication bus 146 for inter-component communications.

Those skilled in the art will recognize that FIG. 3 illustrates only one particular example of the computing device 114, and many other embodiments of the computing device 114 are contemplated including less, more, and/or different components.

Referring to FIG. 1, in accordance with the techniques of the present disclosure, each user 100 of the plurality of users 112 may use an associated computing device 114 to participate in the proximity-based social network 10 (e.g., be part of the proximity-based social networking system 200). In one example, the computing devices 114 may execute web browser applications that may be used to access the proximity-based social networking service. In another example, the computing devices 114 may execute software applications (e.g., instructions) that are specific to the proximity-based social network 10 (e.g., “apps” running on smartphones, tablets, computers, or other computing devices).

Referring briefly to FIG. 3, in one example, the computing device 114 may include a proximity-based networking application 134. The proximity-based networking application 134 may be an application executable by the computing device 114. The proximity-based networking application 134 may include one or more instructions that, when executed by computing device 114 (e.g., by the processor 136), perform one or more operations of the present disclosure (e.g., method 300). The proximity-based networking application 134 may generate and/or send the content 216 associated with the user 100 and the location information for the computing device 114 of the user 100 to the server 202.

In another example, the server 202 may include the proximity-based networking application 134 executable by the server 202 (e.g., by the processor 218) to perform one or more operations of the present disclosure (e.g., method 300). In another example, the computing device 114 and the server 202 may include the proximity-based networking application 134 executable to perform one or more operations of the present disclosure (e.g., method 300).

Referring to FIGS. 1 and 2, the user 100 may interact with the computing device 114 to participate in the proximity-based social networking service provided by the proximity-based social network system 200 by providing location information and distributing content 216 (e.g., digital content) to the server 202. For example, the content 216 may include sharable messages. The messages may include text comments (e.g., updates, announcements, replies), digital photos, videos, user information, or any other appropriate electronic information.

Server 202 may store and manage the content 216 associated with the user 100 in the database 206. As one example, the database 206 may organize the messages (e.g., message data 210) chronologically, by type, by content, etc. As another example, the database 206 may organize identifying data 212 by user, type, etc. The database 206 may include a database, lookup table, array, linked list, or any suitable data structure to store information.

In one example, the most recent message or other identifying information associated with the second user 100b may be received by the first computing device 114a when the bearing 118 of the first computing device 114a is substantially aligned with the location of the second computing device 114b. As another example, a chronological list of messages (e.g., a feed) or other identifying information associated with the second user 100b may be received by the first computing device 114a during the time the bearing 118 of the first computing device 114a is substantially aligned with the location of the second computing device 114b. As another example, messages (e.g., the most recent or a chronological list) or other identifying information associated with the second user 100b may be received by the first computing device 114a during the time the second computing device 114b is within the geo-fence 14 defined by the first user 100a and/or during the time the bearing 118 is generally aligned with the location of the second computing device 114b.

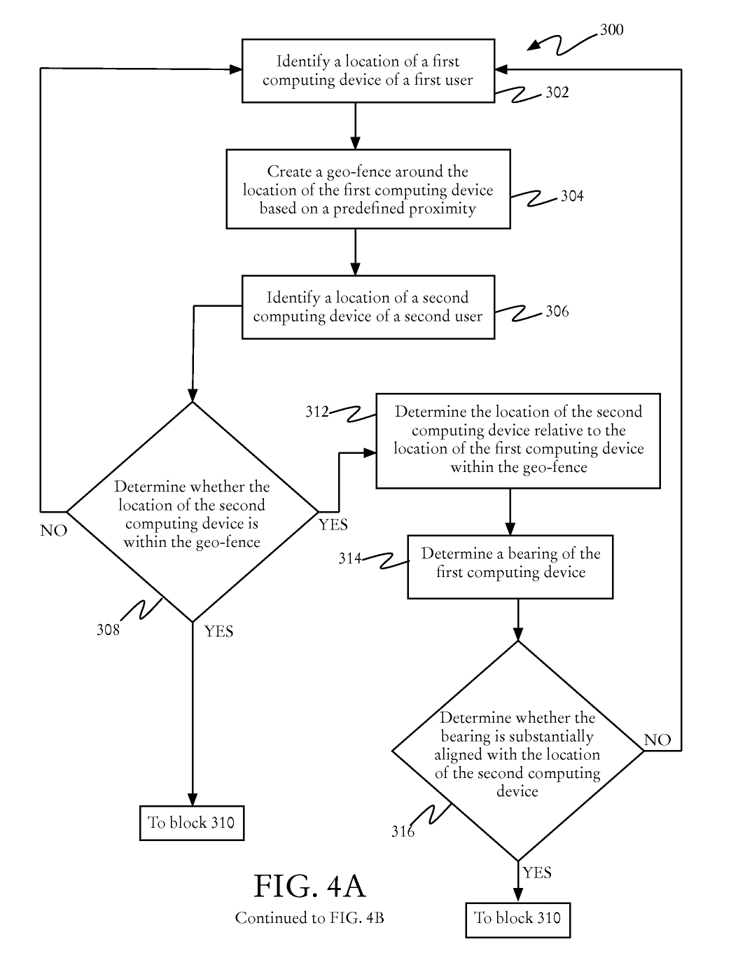

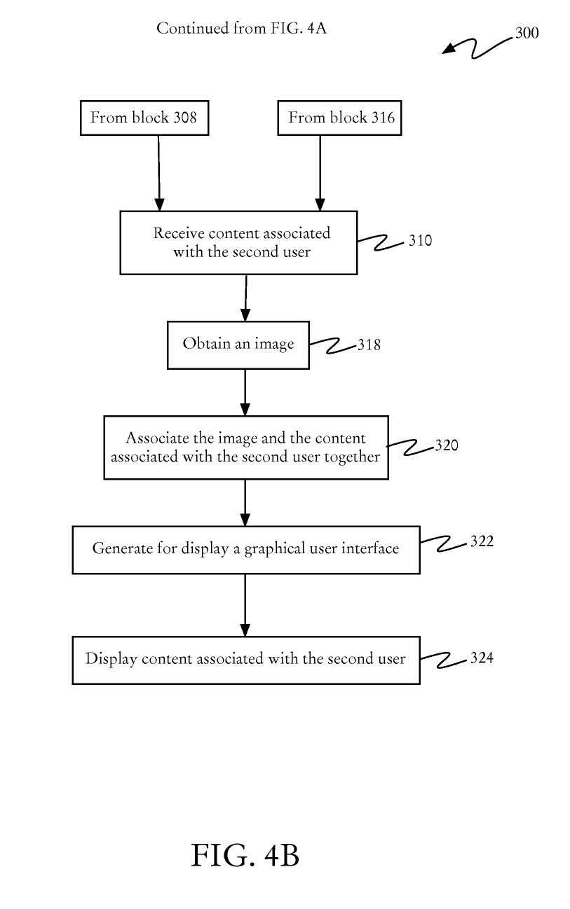

Referring to FIGS. 4A and 4B, and with reference to FIGS. 1 and 2, one embodiment of the disclosed method, generally designated 300, for proximity-based social networking may include a series of operations or steps (e.g., instructions) implemented by the proximity-based social networking system 200 (FIG. 2). As an example, the method 300 (or any operations of the method 300) may be implemented in whole or in part by the computing device 114 and/or the server 202. As one specific, non-limiting example, the method 300 may be implemented by a computer-readable storage medium comprising instructions (e.g., proximity-based networking application 134) that, when executed by a processor (e.g., the processor 136 of the first computing device 114a and/or the processor 218 of the server 202), causes the processor to perform one or more operations of the method 300.

The method 300 may include identifying (e.g., by the first computing device 114a of the first user 100a and/or the server 202) the location of the first computing device 114, as shown at block 302. In one example, the method 300 may further include at least one of detecting (e.g., by the first computing device 114a and/or the server 202) the location of the first computing device 114a, transmitting (e.g., by the first computing device 114a) the location of (e.g., location data 208 for) the first computing device 114a (e.g., to the server 202), and/or storing (e.g., by the server 202) the location of (e.g., location data 208 for) the first computing device 114a (e.g., on the database 206). The identified location of the first computing device 114a (e.g., block 302) may be the location detected by the first computing device 114a.

The method 300 may further include creating (e.g., defining and/or establishing) (e.g., by the first computing device 114a and/or the server 202) the geo-fence 14 around the location of the first computing device 114a (e.g., based on the predefined proximity 12), as shown at block 304. In one example, the predefined proximity 12 may be selected by the first user 100a. The size (e.g., the linear dimension) of the predefined proximity 12 may define the size of the geo-fence 14. The user-selected size of the predefined proximity 12 (e.g., the size of the geo-fence 14) may define the operating condition of the first computing device 114a, such as the type of graphical user interface 400 output (e.g., generated and/or displayed) by the first computing device 14a.

The method may further include identifying (e.g., by the first computing device 114a and/or the server 202) the location of the second computing device 114b of the second user 100b within the predefined proximity 12 (e.g., within the geo-fence 14) of the first computing device 114a, as shown at block 306. In one example, the method 300 may further include at least one of detecting (e.g., by the second computing device 114b of the second user 100b and/or the server 202) the location of the second computing device 114b, transmitting (e.g., by the second computing device 114b) the location of (e.g., location data 208 for) the second computing device 114b (e.g., to the server 202), and/or storing (e.g., by the server 202) the location of (e.g., location data 208 for) the second computing device 114b (e.g., on the database 206). The identified location of the second computing device 114b (e.g., block 306) may be the location detected by the second computing device 114b and transmitted to the server 202. The method 300 may further include transmitting, by the server 202, the location of the second computing device 114b to the first computing device 114a, such as in response to the triggering event.

The method 300 may further include determining (e.g., by the first computing device 114a and/or the server 202) whether the location of the second computing device 114b is within the geo-fence 14, as shown at block 308. In one example, determining whether the location of the second computing device 114b is within the geo-fence 14 may be performed (e.g., executed) by the first computing device 114a. In another example, determining whether the location of the second computing device 114b is within the geo-fence 14 may be performed (e.g., executed) by the server 202 and transmitted to the first computing device 114a, for example, over the network 204.

If the location of the second computing device 114b is not within the geo-fence 14, then the method 300 may continue to update (e.g., identify) the location of the first computing device 114 (e.g., block 302), update (e.g., create) the geo-fence 14 (e.g., block 304) and update (e.g., identify) the location of the second computing device 114b (e.g., block 306).

In one example implementation of the method 300, if the location of the second computing device 114b is within the geo-fence 14, then the method 300 may further include receiving the content 216 associated with the second user 100b, as shown at block 310 (FIG. 4B).

In another example implementation of the method 300, if the location of the second computing device 114b is within the geo-fence 14, then the method 300 may further include determining (e.g., by the first computing device 114a and/or the server 202) the location of the second computing device 114b relative to the location of the first computing device 114a within the geo-fence 14, as shown at block 312.

The method 300 may further include determining (e.g., by the first computing device 114a and/or the server 202) the bearing 118 of the first computing device 114a, as shown at block 314.

The method 300 may further include determining (e.g., by the first computing device 114a and/or the server 202) whether the bearing 118 is substantially aligned with the location of the second computing device 114b, as shown at block 316.

If the bearing 118 of the first computing device 114a is not substantially aligned with the location of the second computing device 114b, the method 300 may continue to update (e.g., identify) the location of the first computing device 114 (e.g., block 302), update (e.g., create) the geo-fence 14 (e.g., block 304) and update (e.g., identify) the location of the second computing device 114b (e.g., block 306).

In one example implementation of the method 300, if the bearing 118 of the first computing device 114a is substantially aligned with the location of the second computing device 114b, then the method 300 may further include receiving the content 216 associated with the second user 100b, as shown at block 310 (FIG. 4B). As one example, the method 300 may further include receiving, by the first computing device 114a, the content 216 associated with the second user 100b occurring at the time, when, and/or during the time the bearing 118 is substantially aligned with the location of the second computing device 114b.

In one example, the method 300 may further include at least one of generating (e.g., by the second computing device 114b) the content 216 associated with the second user 100b, transmitting (e.g., by the second computing device 114b) the content 216 associated with the second user 100b (e.g., to the first computing device 114a and/or the server 202), and/or storing (e.g., by the server 202) the content 216 associated with the second user 100b (e.g., on the database 206).

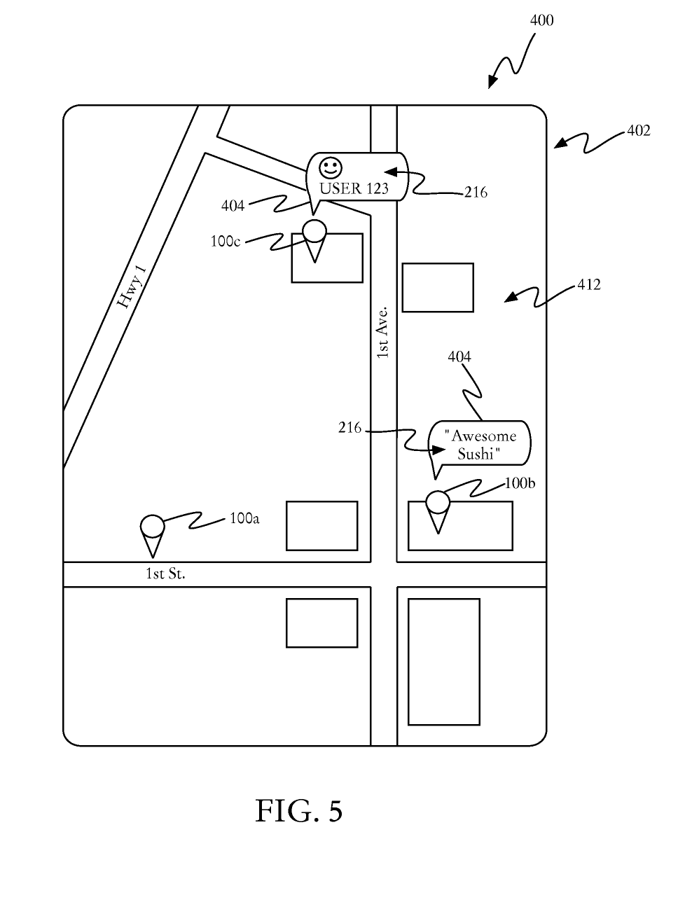

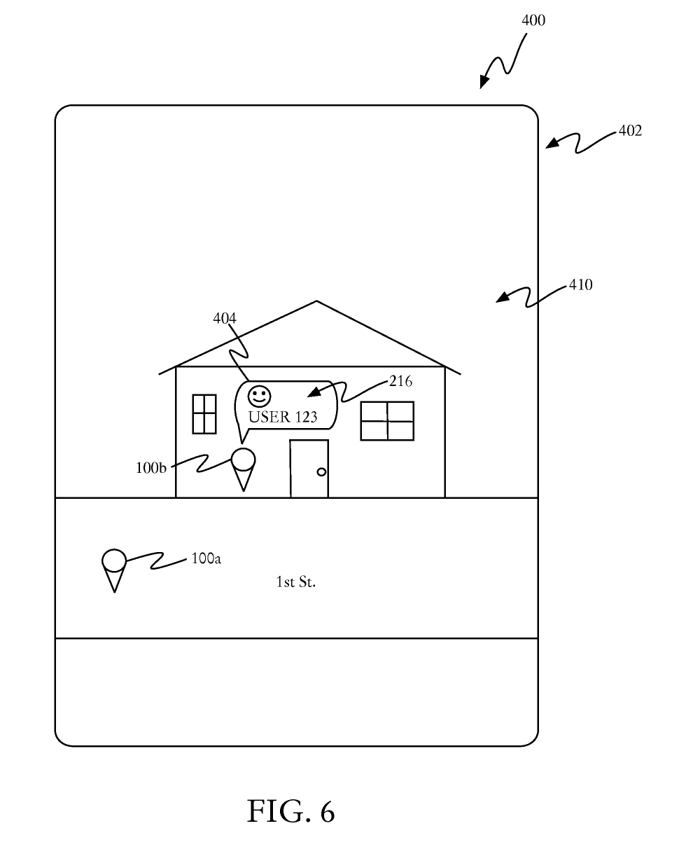

Referring to FIG. 4B, the method 300 may further include obtaining an image 402 (e.g., image data 214), as shown at block 318. In one example, the image 402 may include a street-level image 410 (FIG. 5) of a geographic area delimited by the geo-fence 14. In another example, the image 402 may include a plan view (e.g., an orthogonal overhead view) map image 412 (FIG. 6) of the geographic area delimited by the geo-fence 14. In another example, the image 402 may include a live image 414 of a field of view of the first computing device 114a (e.g., the field of view of a camera (e.g., input device 130) of the first computing device 114a) at the bearing of the first computing device 114a. The image 402 (e.g., image data 214) may depend on the size of the predefined proximity 12 (e.g., the size of the geo-fence 14), the operating condition of the first computing device 114a, and/or the triggering event.

The method 300 may further include associating the image 402 and the content 216 associated with the second user 100b together, as shown at block 320. In one example, the street-level image 410 and the content 216 associated with the second user 100b may be associated together in response to the location of the second computing device 114b being within the geo-fence 14. In another example, the map image 412 and the content 216 associated with the second user 100b may be associated together in response to the location of the second computing device 114b being within the geo-fence 14. In another example, the live image 414 and the content 216 associated with the second user 100b may be associated together in response to the bearing 118 of the first computing device 114a being substantially aligned with the location of the second computing device 114b.

Referring to FIG. 4B, and with reference to FIGS. 5-7, the method 300 may further include generating for display (e.g., by the first computing device 114a and/or the server 202) the graphical user interface 400, as shown at block 322. In one example, the graphical user interface 400 may include the street-level image 410 of the geographic area delimited by the geo-fence 14 and a rendering 404 of the content 216 associated with the second user 100b superimposed proximate the location of the second computing device 114b within the street-level image 410. In another example, the graphical user interface 400 may include the map image 412 of the geographic area delimited by the geo-fence 14 and the rendering 404 of the content 216 associated with the second user 100b superimposed proximate the location of the second computing device 114b within the map image 412. In another example, the graphical user interface 400 may include the live image 414 of the field of view 152 of the first computing device 114a at the bearing 118 of the first computing device 114a and the rendering 404 of the content 216 associated with the second user 100b superimposed proximate the location of the second computing device 114b within the live image 414.

Referring to FIG. 4B, the method 300 may further include displaying (e.g., by the first computing device 114a) the content 216 associated with the second user 100b, as shown at block 324. In one example, the content 216 associated with the second user 100b may be displayed on the first computing device 114a by the graphical user interface 400 (e.g., the image 402 and the rendering of the content 216 associated with the second user 100b on the image 402).

Displaying the content 216 associated with the second user 100b (e.g., on the graphical user interface 400) may be initiated by the triggering event based on the operating condition of the first computing device 114a. In one example, the user 100 (e.g., the first user 100a) may select the operating condition and, thus, the triggering event and/or the graphical user interface 400 displayed by the computing device 114 (e.g., the first computing device 114a).

Referring to FIG. 5, one example of a first operating condition may include displaying the graphical user interface 400 including the plan view map image 412 and the rendering 404 of the content 216 associated with the second user 100b (and/or the third user 100c, the fourth user 100d, the fifth user 100e, etc.). As one example, the predefined proximity 12 may be set relatively large (e.g., at about 1000 meters) to define a relatively large geo-fence 14 delimiting a relatively large geographic area (e.g., a neighborhood, a city block, etc.). The map image 412 may be an existing (e.g., pre-obtained) map image of the geographic area. As one example, the map image 412 may be created from a web-based (e.g., desktop or mobile) mapping service application offering graphical map and/or satellite imagery of the geographic area. As one specific, non-limiting example, the map images 412 may be provided by Google Maps™ mapping service. The location of the first computing device 114a and the second computing device 114b (and/or the third user 100c, the fourth user 100d, the fifth user 100e, etc.) may be regularly updated in response to movement and the rendering of the content 216 may be located proximate to the current location of the second computing device 114b.

In one example implementation of the first operating condition, the triggering event may include the second computing device 114b being located within the predefined proximity 12 (e.g., locating within the geo-fence 14). As such, the map image 412 depicting the current location of the first computing device 114a (e.g., the current geo-fence 14) and the rendering 404 of the content 216 associated with the second user 100b (and/or the third user 100c, the fourth user 100d, the fifth user 100e, etc.) proximate (e.g., at or near) the location of the second user 100b (e.g., the location of the second computing device 114b) on the map image 412 may be automatically displayed by the first computing device 114a (e.g., on the graphical user interface 400).

Referring to FIG. 6, one example of a second operating condition may include displaying the graphical user interface 400 including the street-level image 410 and the rendering 404 of the content 216 associated with the second user 100b (and/or the third user 100c, the fourth user 100d, the fifth user 100e, etc.). As one example, the predefined proximity 12 may be set relatively smaller than the first operating condition (e.g., at about 100 meters) to define a relatively smaller geo-fence 14 delimiting a relatively smaller geographic area (e.g., a portion of a street, a building, etc.). The street-level image 410 may be an existing (e.g., pre-obtained) street-level photographic image of the geographic area. As one example, the street-level image 410 may be created from a web-based (e.g., desktop or mobile) mapping service application offering (e.g., providing) panoramic views from positions along streets of the geographic area. As one specific, non-limiting example, the street-level images 410 may be provided by Google Street View™ mapping service featured in Google Maps™. The location of the first computing device 114a and the second computing device 114b (and/or the third user 100c, the fourth user 100d, the fifth user 100e, etc.) may be regularly updated in response to movement and the rendering of the content 216 may be located proximate to the current location of the second computing device 114b.

In one example implementation of the second operating condition, the triggering event may include the second computing device 114b being located within the predefined proximity 12 (e.g., locating within the geo-fence 14). As such, the street-level image 410 depicting the current location of the first computing device 114a (e.g., the current geo-fence 14) and the rendering 404 of the content 216 associated with the second user 100b (and/or the third user 100c, the fourth user 100d, the fifth user 100e, etc.) proximate the location of the second user 100b (e.g., the location of the second computing device 114b) on the street-level image 410 may be automatically displayed by the first computing device 114a (e.g., on the graphical user interface 400).

In another example implementation of the second operating condition, the triggering event may include the second computing device 114b being located within the predefined proximity 12 and the bearing 118 of the first computing device 118 being generally aligned with the location of the second computing device 114b. As such, the street-level image 410 depicting the current location of the first computing device 114a (e.g., the current geo-fence 14) and the rendering 404 of the content 216 associated with the second user 100b (and/or the third user 100c, the fourth user 100d, the fifth user 100e, etc.) proximate the location of the second user 100b (e.g., the location of the second computing device 114b) on the street-level image 410 may be displayed by the first computing device 114a (e.g., on the graphical user interface 400) if the first computing device 114a is generally facing the location of the second computing device 100b (e.g., the second user 100b).

Referring to FIG. 7, one example of a third operating condition may include displaying the graphical user interface 400 including the live image 414 and the rendering 404 of the content 216 associated with the second user 100b (and/or the third user 100c, the fourth user 100d, the fifth user 100e, etc.). As one example, the predefined proximity 12 may be set relatively small (e.g., smaller than the first and second operating condition) (e.g., at about 10 meters) to define a relatively small geo-fence 14 delimiting a relatively small geographic area (e.g., a room, general vicinity of the first user 100, etc.). The live image 414 may be a live image (e.g., a photographic or videographic image) obtained by the first computing device 100a (e.g., by the camera of the first computing device 100a) at the bearing 118 of the first computing device 114a. The location of the first computing device 114a and the second computing device 114b (and/or the third user 100c, the fourth user 100d, the fifth user 100e, etc.) may be regularly updated in response to movement and the rendering 404 of the content 216 may be located proximate to the current location of the second user 100b (e.g., the second computing device 114b) relative to the first user 100a e.g., the first computing device 114a).

In one example implementation of the third operating condition, the triggering event may include the second computing device 114b being located within the predefined proximity 12 and the bearing 118 of the first computing device 118 being substantially aligned with the location of the second computing device 114b. As such, the live image 414 depicting the live scene within the field of view 152 of the first computing device 114a at the bearing 118 of the first computing device 114a and the rendering 404 of the content 216 associated with the second user 100b (and/or the third user 100c, the fourth user 100d, the fifth user 100e, etc.) proximate the location of the second user 100b (e.g., the location of the second computing device 114b) on the live image 414 may be displayed by the first computing device 114a (e.g., on the graphical user interface 400) if the first computing device 114a is substantially facing the location of the second computing device 100b (e.g., the second user 100b).

As one example, as the first computing device 114a is moved or panned (e.g., as the bearing 118 is moved), the live image 414 displayed by the first computing device 114a may depict locations, objects, and/or people within the field of view 152 of the first computing device 114a (e.g., of the camera). When the bearing 118 of the first computing device 114a is substantially aligned with the location of the second computing device 114b, the content 216 associated with the second user 100b may be associated with the live image 414 and the rendering 404 of the content 216 may be positioned on the live image 414 proximate the second user 100b.

The distance from the first computing device 114a to the second computing device 114b may be useful for various purposes. As one example, the distance from the first computing device 114a to the second computing device 114b may be useful for identifying the second user 100b (the second computing device 114b) as the computing device 114 being viewed by the first user 100a (the first computing device 114a). As another example, the distance from the first computing device 114a to the second computing device 114b may be useful for properly positioning the rendering 404 of the content 216 within the image 402 relative to the location of the second user 100b (e.g., the second computing device 114b).

While the distance from the first computing device 114a to the second computing device 114b may be determined by the system 200 from the known locations of the second computing device 114b relative to the first computing device 114a (e.g., by GPS and/or compass data), other techniques (e.g., non-system 200-based techniques) may also be used to determine the distance. As one example, the distance from the first computing device 114a to the second computing device 114b may be determined by the first computing device 114a using a camera (e.g., input device 130) of the first computing device 114a, such as by the focusing and/or depth sensing ability of the camera. As another example, the distance from the first computing device 114a to the second computing device 114b may be determined by RFID and/or near-field communication. As yet another example, the distance from the first computing device 114a to the second computing device 114b may be determined using a Bluetooth® device, such as by evaluating Bluetooth® signal strength (RSSI value).

In one example, the rendering 404 of the content 216 may take the form of a caption (e.g., a speech balloon or thought balloon) superimposed proximate (e.g., at or near) the location of the second user 100b within the image 402. For example, the first computing device 114a may use facial recognition applications and/or software to recognize and/or locate the face of the second user 100b and position the speech balloon relative to the face of the second user 100b, as best illustrated in FIG. 7.

As one example, the content 216 may include a message from the second user 100b, as best illustrated in FIG. 7. As another example, the content 216 may include identifying information (e.g., a username and/or avatar of the second user 100b), as best shown in FIGS. 5 and 6. In one example, the identifying information may be displayed when no current messages associated with the second user 110b are available. In another example, the second user 100b may select the type of content 216 to be displayed (e.g., the second user 100b may select identifying information instead of messages associated with the second user 100b).

In one example implementation, obtaining the image 402, receiving the content 216 associated with the second user 100b, associating the image 402 and the content 216, and/or displaying the image 402 and the rendering 404 of the content 216 (e.g., generating the graphical user interface 400) may be performed by the proximity-based networking application 134 and executed by the first computing device 114a and/or the server 202.

In this way, a user 100 of the proximity-based social networking service may discover and share content with other users 100 using the proximity-based social networking service in proximity to the user 100 (e.g., within the predefined proximity 12 of the user 100).

In one example implementation of the disclosed method 300, the proximity-based social networking service may be used to socially connect users 100 and communicate between users 100 based on their immediate proximity to one another. As one example, the predefined proximity 12 may be set to delimit the geo-fence 14 within a restaurant, a bar, a sports arena, etc. Upon display of the content 216 associated with the second user 100b within the geo-fence 14, the first user 100a may initiate direct communication with the second user 100b.

In another example implementation of the disclosed method 300, the proximity-based networking service may be used to identify and/or reward users 100 in an employment setting. As one example, the predefined proximity 12 may be set to delimit the geo-fence 14 within an office building, manufacturing facility or other workspace. The first user 100a (e.g., an employer) may be able to locate and identify the second user 100b (e.g., an employee) using the disclosed method 300.

As noted above, the proximity-based networking application 134 may include one or more filters configured to limit which users 100 are displayed by the first computing device 114a (e.g., on the graphical user interface 400). In one example, only users 100 having identifying information (e.g., identifying data 212) indicating employment by employer may be displayed within the geo-fence 14.

As another example, the proximity-based networking application 134 may include recognition and/or reward operation configured to enable the first user 100a (e.g., the employer) to recognize and/or reward the second user 100b (e.g., the employee) directly through the graphical user interface 400. In one example, the first user 100a (e.g., the employer) may post content 216 associated with the second user 100b (e.g., the employee) for other users 100 of the proximity-based social network 10 to see, such as critiques or acknowledgements of good work. In another example, the first user 100a (e.g., the employer) may award cash, credits and/or points to the second user 100b (e.g., the employee), which may be redeemed for a reward.

Accordingly, the disclosed system and method for proximity-based social networking may allow a user to create (e.g., define) a temporary proximity-based social network including a plurality of other users located within a predefined proximity of the user. Examples of the disclosed system and method may not require proactively connecting to other users (e.g., “friends” or “followers”) in order to communicate with the other users, instead users of the disclosed proximity-based social networking system may automatically communicate with other users based on their geographic proximity.

Although various embodiments of the disclosed system and method for proximity-based social networking have been shown and described, modifications may occur to those skilled in the art upon reading the specification. The present application includes such modifications and is limited only by the scope of the claims.

What is claimed is:

1. A method for proximity-based social networking comprising:
obtaining social media messages associated with users, wherein said social media messages comprise at least one of text content, audio content, video content, and image content created by said users;
establishing a proximity-based communication network between computing devices operated by said users, wherein a boundary of said proximity-based network is defined by a predetermined proximity of said computing devices;
making said social media messages available for presentation to said computing devices located within said boundary;
determining that a current bearing of a first one of said computing devices operated by a first one of said users is aligned with a second one of said computing devices operated by a second one of said users; and
automatically presenting to said first one of said computing devices one of said social media messages associated with said second one of said users when said first one and said second one of said computing devices are located within said boundary and are aligned.

2. The method of claim 1 wherein establishing said proximity-based communication network between said computing devices operated by said users comprises:
obtaining a current location of said first one of said computing devices;
establishing a geo-fence around said current location of said first one of said computing devices;
obtaining a current location of said second one of said computing devices;
determining that said current location of said second one of said computing devices is within said geo-fence; and
enabling a communications transaction between said first one of said computing devices and said second one of said computing devices.

3-4. (canceled)

5. The method of claim 2 further comprising:
presenting to said first one of said computing devices said current location of said second one of said computing devices relative to said current location of said first one of said computing devices.

6. The method of claim 5 wherein:
presenting to said first one of said computing devices said current location of said second one of said computing devices relative to said current location of said first one of said computing devices comprises:
obtaining a map image representing a geographic area delimited by said geo-fence; and
displaying said current location of said second one of said computing devices superimposed on said map image; and
presenting to said first one of said computing devices said at least one of said social media messages associated with said second one of said users comprises displaying said at least one of said social media messages superimposed proximate to said current location of said second one of said computing devices.

7. (canceled)

8. The method of claim 2 wherein determining that said current bearing of said first one of said computing devices is aligned with said second one of said computing devices comprises:
obtaining a vector representing at least one of a current orientation, a current angular position, and a current attitude of said first one of said computing devices relative to said current location of said second one of said computing devices; and
determining that said vector is within approximately five degrees to approximately twenty-five degrees of said current location of said second one of said computing devices.

9. The method of claim 5 wherein:
presenting to said first one of said computing devices said current location of said second one of said computing devices relative to said current location of said first one of said computing devices comprises:
obtaining a live image representing a field of view of said first one of said computing devices corresponding to said current bearing of said first one of said computing devices;
displaying said current location of said second one of said computing devices superimposed on said live image; and
presenting to said first one of said computing devices said at least one of said social media messages associated with said second one of said users comprises displaying said at least one of said social media messages superimposed proximate to said current location of said second one of said computing devices.

10. (canceled)

11. A system for a proximity-based social network comprising:
computing devices operated by users; and
a server in communication with said computing devices, wherein said server is configured to:
obtain social media messages associated with said users, wherein said social media messages comprise at least one of text content, audio content, video content, and image content;
establish a proximity-based communication network between said computing devices, wherein a boundary of said proximity-based network is defined by a predetermined proximity of said computing devices;
make said social media messages available for presentation to said computing devices located within said boundary;
determine that a current bearing of a first one of said computing devices operated by a first one of said users is aligned with a second one of said computing devices operated by a second one of said users; and
automatically present one of said social media messages associated with said second one of said users to said first one of said computing devices when said first one and said second one of said computing devices are located within said boundary and are aligned.

12. The system of claim 11 wherein said server is further configured to:
obtain a current location of said first one of said computing devices;
establish a geo-fence around said current location of said first one of said computing devices;
obtain a current location of said second one of said computing devices;
determine that said current location of said second one of said computing devices is within said geo-fence; and
enable a communications transaction between said first one of said computing devices and said second one of said computing devices.

13-14. (canceled)

15. The system of claim 12 wherein said server is further configured to:
present said current location of said second one of said computing devices relative to said current location of said first one of said computing devices to said first one of said computing devices.

16. The system of claim 12 wherein said server is further configured to:
obtain a vector representing at least one of a current orientation, a current angular position, and a current attitude of said first one of said computing devices relative to said current location of said second one of said computing devices; and
determine that said vector is within approximately five degrees to approximately twenty-five degrees of said current location of said second one of said computing devices.

17. The system of claim 15 wherein said server is further configured to:
obtain a live image representing a field of view of said first one of said computing devices corresponding to said current bearing of said first one of said computing devices; and
render a displayable image comprising said live image, said current location of said second one of said computing devices superimposed on said live image, and said one of said social media messages associated with said second user superimposed on said live image proximate said current location of said second one of said computing devices.

18. The system of claim 15 wherein said server is further configured to:
obtain a street-level image representing a geographic area corresponding to said current bearing of said first one of said computing devices; and
render a displayable image comprising said street-level image, said current location of said second one of said computing devices superimposed on said street-level image, and said one of said social media messages associated with said second user superimposed on said street-level image proximate said current location of said second one of said computing devices.

19. A non-transitory computer-readable storage medium comprising instructions that, when executed by a processor, causes said processor to perform operations comprising:
obtaining social media messages associated with users, wherein said social media messages comprise at least one of text content, audio content, video content, and image content created by said users;
establishing a proximity-based communication network between computing devices operated by said users, wherein a boundary of said proximity-based network is defined by a predetermined proximity of said computing devices;
making said social media messages available for presentation to said computing devices located within said boundary;
determining that a current bearing of a first one of said computing devices operated by a first one of said users is aligned with a second one of said computing devices operated by a second one of said users; and
automatically presenting to said first one of said computing devices one of said social media messages associated with said second one of said users when said first one and said second one of said computing devices are located within said boundary and are aligned.

20. The non-transitory computer-readable medium of claim 19 wherein said operations further comprise:
obtaining an identification associated with said second one of said users;
obtaining a current location of said first one of said computing devices;
obtaining a current location of said second one of said computing devices; and
presenting to said first one of said computing devices at least one of said current location of said second one of said computing devices relative to said current location of said first one of said computing devices and one of said identification associated with said second one of said users.

21. The method of claim 5 wherein:
presenting to said first one of said computing devices said current location of said second one of said computing devices relative to said current location of said first one of said computing devices comprises:
obtaining a street-level image representing a geographic area corresponding to said current bearing of said first one of said computing devices; and
displaying said current location of said second one of said computing devices superimposed on said street-level image; and
presenting to said first one of said computing devices said at least one of said social media messages associated with said second one of said users comprises displaying said at least one of said social media messages superimposed proximate to said current location of said second one of said computing devices.

22. The method of claim 5 further comprising:
obtaining identifications associated with said users; and
presenting to said first one of said computing devices one of said identifications associated with said second one of said users.

23. The method of claim 22 further comprising:
requesting permission for said communications transaction by said first one of said computing devices;
authorizing said communications transaction by said second one of said computing devices;
retrieving at least one of said one of said social media messages associated with said second one of said users, said current location of said second one of said computing devices, and said one of said identifications associated with said second one of said users; and
communicating said at least one of said one of said social media messages associated with said second one of said users, said current location of said second one of said computing devices, and said one of said identifications associated with said second one of said users to said first one of said computing devices in response to said current bearing of said first one of said computing devices being aligned with said second one of said computing devices.

24. The method of claim 23 further comprising applying a filter that limits communication of said at least one of said one of said social media messages associated with said second one of said users, said current location of said second one of said computing devices, and said one of said identifications associated with said second one of said users.

25. The system of claim 15 wherein said server is further configured to:
obtain a map image representing a geographic area delimited by said geo-fence; and
render a displayable image comprising said map image, said current location of said second one of said computing devices superimposed on said map image, and said one of said social media messages associated with said second user superimposed on said map image proximate said current location of said second one of said computing devices.

26. The system of claim 15 wherein said server is further configured to:
obtain identifications associated with said users; and
present one of said identifications associated with said second one of said users to said first one of said computing devices.
